(19) United States
(12) Patent Application Publication
(10) Pub. No.: US 2008/0074407 A1
(43) Pub. Date: Mar. 27, 2008

(54) Display device with temperature compensation and driving method of same

(75) Inventors: Wei Zhou, Shenzhen (CN); Sai-Xin Guan, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY(SHENZHEN) CO., LTD.; INNOLUX DISPLAY CORP.

(21) Appl. No.: 11/903,856

(22) Filed: Sep. 24, 2007

(30) Foreign Application Priority Data
Sep. 22, 2006 (TW) 95135188

(51) Int. Cl. G09G 3/36; G09G 3/00

(52) U.S. Cl. 345/204; 345/101

(57) ABSTRACT

An exemplary display device (200) includes a control circuit (22), a driving circuit (24), and a display module (25). The control circuit is configured to generate temperature compensation values according to ambient temperature signals inputted to the control circuit. The driving circuit is configured to generate compensated display signals according to the temperature compensation value generated by the control circuit. The display module is configured to receive the compensated display signals outputted by the driving circuit, and display images under the control of the compensated display signals. A method for driving the display device is also provided.

### FIELD OF THE INVENTION

The present invention relates to display devices and, particularly, to a display device capable of automatically adjusting display signals according to ambient temperature. The present invention also relates to a method for driving such display device.

### GENERAL BACKGROUND

Display devices are widely used in various modern information products, such as notebooks, personal digital assistants (PDAs), video cameras, mobile phones and the like. Some display devices provide a function of temperature detection, in order that the user is made aware of the ambient temperature.

FIG. 3 is an exploded diagram of a conventional display device with temperature detection function. The display device can be a mobile phone, for example. The display device 100 includes a shell 10, a keyboard 11, a control circuit 12, a display module 13, and a temperature sensor 14. The shell 10 includes an outer surface (not labeled) and an inner accommodating space (not labeled). The keyboard 11 is installed at the outer surface of the shell 10, and the display module 13 is installed in the inner accommodating space of the shell 10.

The display module 13 includes a main display area 15, and a peripheral non-display area (not labeled) surrounding the display area 15. The control circuit 12 and the temperature sensor 14 are both disposed on the non-display area 15 of the display module 13. Moreover, the control circuit 12 is electrically coupled to the temperature sensor 14 and the display module 13, respectively. The temperature sensor 14 is a thermal diode.

In operation, the temperature sensor 14 detects the ambient temperature, converts a corresponding temperature signal to an analog electrical signal, and then outputs the analog electrical signal to the control circuit 12. The control circuit 12 converts the analog electrical signal to a digital signal, and outputs the digital signal to the display module 13. Finally, the display module 13 generates a display voltage according to the digital signal, and displays a corresponding numerical value in the display area 15 based on the display voltage. Thus, a numerical value representing the ambient temperature appears on the display device 100, and can be conveniently read by a user.

The ambient temperature is liable to influence electrical characteristics of inner elements in the display device 100. That is, when the display device 100 is used in different environments, the electrical characteristics of the inner elements are apt to vary. For example, if the ambient temperature increases, the mobility of electrons in inner transistors of the display device 100 increases accordingly, so as to reduce the threshold voltages of the transistors. Therefore, output signals of the display device 100 are liable to drift. In the display device 100, although alterations in the ambient temperature can be easily seen on the display module 13, the problem of output signal drift caused by such alterations is not addressed. Ambient temperature changes can cause a variety of display defects on the display device 100, such as unwanted increased response time, a decrease in the contrast ratio, flicker phenomenon, and the like. All these defects reduce the quality of the display.

It is, therefore, desired to provide a display device which overcomes the above-described deficiencies.

### SUMMARY

In one aspect, a display device includes a control circuit, a driving circuit, and a display module. The control circuit is configured to generate temperature compensation values according to ambient temperature signals inputted to the control circuit. The driving circuit is configured to generate compensated display signals according to the temperature compensation value. The display module is configured to receive the compensated display signals, and display images under the control of the compensated display signals.

In another aspect, a method for driving a liquid crystal display includes: detecting ambient temperature; generating temperature compensation values according to the ambient temperature; generating compensated display signals according to the temperature compensation values; and outputting the compensated display signals to a display module to drive the display module.

Other novel features and advantages will become more apparent from the following detailed description when taken in conjunction with the accompanying drawings.

### BRIEF DESCRIPTION OF THE DRAWINGS

FIG. 1 is a block diagram of main components of a display device according to an exemplary embodiment of the present invention.

FIG. 2 is a block diagram of a control circuit of the display device of FIG. 1.

FIG. 3 is essentially an exploded, isometric view of a conventional display device with temperature detection function.

### DETAILED DESCRIPTION OF PREFERRED EMBODIMENTS

Reference will now be made to the drawings to describe preferred and exemplary embodiments of the present invention in detail.

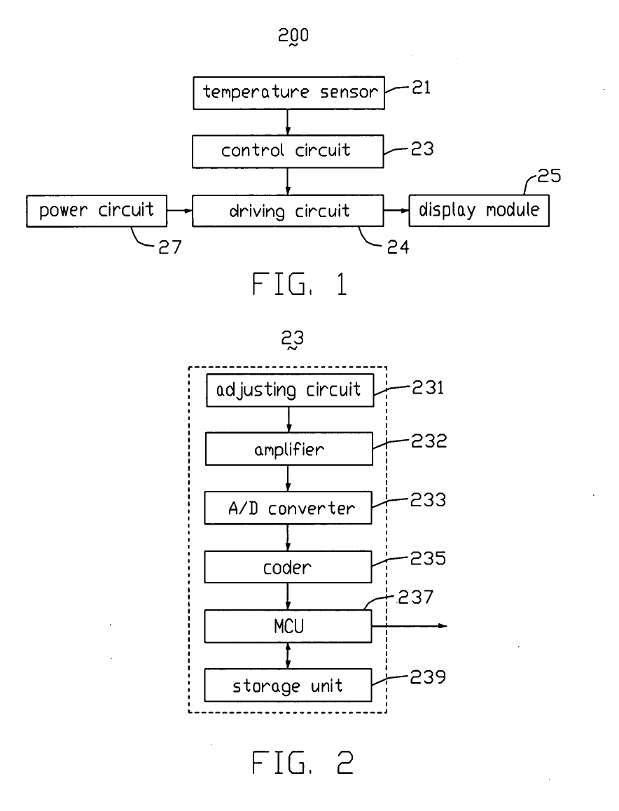

FIG. 1 is a block abbreviated diagram of a display device according to an exemplary embodiment of the present invention. The display device 200 is capable of automatically compensating display signals according to ambient temperature, and can for example be a mobile phone. The display device 200 includes a temperature sensor 21, a control circuit 23, a driving circuit 24, a display module 25, and a power circuit 27. Typically, the temperature sensor 21, the control circuit 23, the display driving circuit 24, and the power circuit 27 are all disposed in the display module 25.

The temperature sensor 21 is configured to convert an ambient temperature signal to an electrical signal, and is electrically coupled to the control circuit 23. In the exemplary embodiment, the electrical signal is an analog voltage signal, which is outputted to the control circuit 23. The temperature sensor 21 is typically a thermal diode. However, the temperature sensor 21 can instead be another kind of thermal sensing device, such as a thermal resistor, a thermal coupler, an infrared thermometer sensor, a microwave thermometer sensor, and the like.

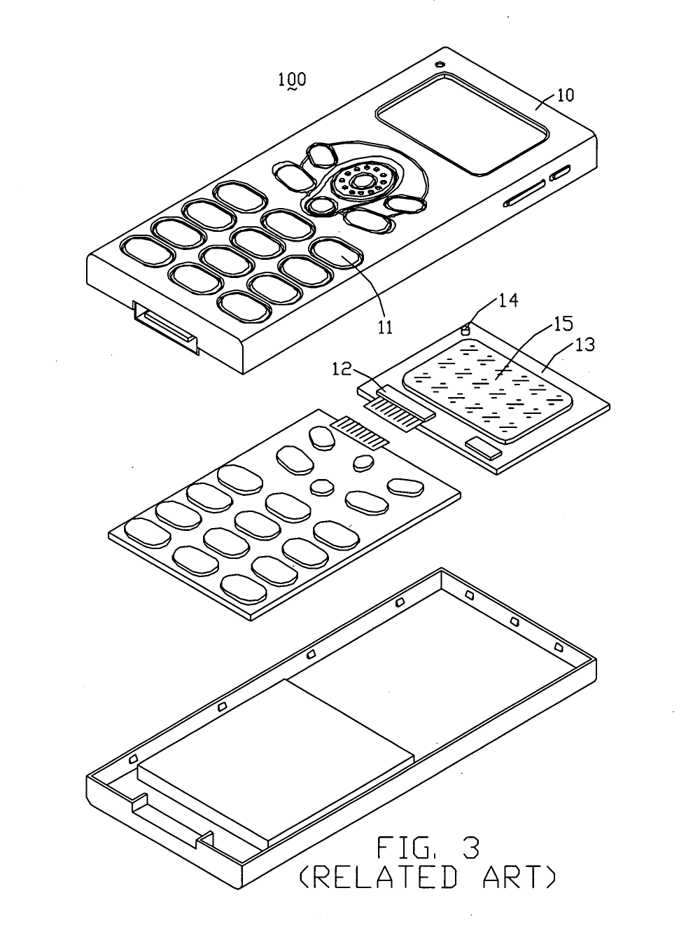

FIG. 2 is a block diagram of the control circuit 23. The control circuit 23 is configured to provide a temperature compensation value according to the electrical signal generated by the temperature sensor 21. The control circuit 23 includes an adjusting circuit 231, an amplifier 232, an analog to digital (A/D) converter 233, a coder 235, a micro control unit (MCU) 237, and a storage unit 239. The adjusting circuit 231, the amplifier 232, the A/D converter 233, the coder 235, and the MCU 237 are electrically coupled between the temperature sensor 21 and the driving circuit 24 in series. The storage unit 239 is electrically coupled to the MCU 237.

The adjusting circuit 231 is configured to adjust the analog voltage signal, so as to filter incidental interference signals simultaneously generated together with the analog voltage signal by the temperature sensor 21. The amplifier 232 is configured to amplify the adjusted analog voltage signal. The A/D converter 233 is configured to convert the analog voltage signal outputted by the amplifier 232 to a digital signal. The coder 235 is configured to compress and code the digital signal to a binary code. Moreover, the storage unit 239 includes a plurality of temperature compensation values, each of which corresponds to a respective binary code. Once the MCU 239 receives a binary code from the coder 235, it reads a corresponding temperature compensation value from the storage unit 239, and outputs the temperature compensation value to the driving circuit 24.

Referring to FIG. 1, the driving circuit 24 is electrically coupled between the power circuit 27 and the display module 25. The driving circuit 24 is configured to drive the display module 25 to display images according to the display signals and the temperature compensation value it receives. In addition, the power circuit 27 is configured to provide electrical power to the driving circuit 24. The display module 25 can for example include a flat panel display (FPD), such as a liquid crystal display (LCD), a plasma display, an organic light emitting display (OLED), and the like.

Operation of the display device 200 is typically as follows. When the ambient temperature of the display device 200 varies, a kinetic energy of inner conductive particles of the temperature sensor 21 increases or decreases accordingly. The inner conductive particles may for example be electrons and associated holes. The increase or decrease in kinetic energy causes the temperature sensor 21 to output an analog voltage signal to the control circuit 23, the analog voltage signal corresponding to the ambient temperature.

When the control circuit 23 receives the analog voltage signal, it filters the incidental interference signals from the analog voltage signal via the adjusting circuit 231, and subsequently amplifies the adjusted analog voltage signal via the amplifier 232. The analog voltage signal is then outputted to the A/D converter 233 by the amplifier 232. In the A/D converter 233, the analog voltage signal is sampled and quantized, so that it is converted to a digital signal. The digital signal is then outputted to the coder 235. The coder 235 compresses and codes the digital signal, so that the digital signal is converted to a binary code. The binary code can be easily identified by the MCU 237. The MCU 237 receives the binary code from the coder 235, looks up a corresponding temperature compensation value from the storage unit 239, and reads the corresponding temperature compensation value. In detail, when the binary code indicates that the ambient temperature has increased, the MCU 237 reads a temperature compensation value that corresponds to a negative compensation voltage. When the binary code indicates that the ambient temperature has decreased, the MCU 237 reads a temperature compensation value that corresponds to a positive compensation voltage. A value of each of the negative compensation voltage and the positive compensation voltage depends on the amount of alteration of the ambient temperature. Then the MCU 237 outputs the temperature compensation value to the driving circuit 24.

The driving circuit 24 receives a display signal from a peripheral circuit (not shown) such as a timing controller. The received display signal is independent of the temperature compensation value. The driving circuit 24 converts the display signal to a display voltage. The driving circuit 24 receives the temperature compensation value from the MCU 237 simultaneously with the display signal, and converts the temperature compensation value to the corresponding compensation voltage. Subsequently, the driving circuit 24 adds the compensation voltage to the display voltage, so as to regulate the display voltage output by the driving circuit 24. Thus, when the ambient temperature has increased, the compensation voltage is negative, and the output display voltage is reduced. Conversely, when the ambient temperature has decreased, the compensation voltage is positive, and the output display voltage is increased. Thereby, display voltage drift that would otherwise occur due to the change in the ambient temperature is automatically compensated.

Finally, the output display voltage is outputted to the display module 25, and drives the display module 25 to display images.

In summary, the display device 200 regulates the display signal according to the alteration in the ambient temperature as detected by the temperature sensor 21. The temperature sensor 21 together with the control circuit 23 and the driving circuit 24 cooperate so as to compensate for any drift in the display signal that would otherwise occur due to the change in the ambient temperature. Thus, the display device 200 avoids being influenced by the ambient temperature. In particular, display defects otherwise caused by changes in the ambient temperature are reduced or even eliminated, and the quality of the display is improved.

It is to be understood, however, that even though numerous characteristics and advantages of preferred and exemplary embodiments have been set out in the foregoing description, together with details of the structures and functions of the embodiments, the disclosure is illustrative only; and that changes may be made in detail within the principles of present invention to the full extent indicated by the broad general meaning of the terms in which the appended claims are expressed.

What is claimed is:

1. A display device, comprising:
a control circuit configured to generate temperature compensation values
according to ambient temperature signals inputted to the control circuit; a driving circuit configured to generate compensated display signals according to the temperature compensation values generated by the control circuit; and
a display module configured to receive the compensated display signals outputted by the driving circuit, and display images under the control of the compensated display signals.

2. The display device as claimed in claim 1, further comprising a temperature sensor that is configured to detect the ambient temperature, generate an electrical signal according to the ambient temperature, and output the electrical signal to the control circuit.

3. The display device as claimed in claim 2, wherein the electrical signal is an analog signal.

4. The display device as claimed in claim 2, wherein the temperature sensor is one of a thermal diode, a thermal resistor, a thermal coupler, an infrared thermometer sensor, and a microwave thermometer sensor.

5. The display device as claimed in claim 3, wherein the control circuit comprises an analog to digital converter, and the analog to digital converter is configured to convert the analog signal to a digital signal.

6. The display device as claimed in claim 5, wherein the control circuit further comprises a coder electrically coupled to the analog to digital converter, and the coder is configured to convert the digital signal to a binary code.

7. The display device as claimed in claim 6, wherein the control circuit further comprises a storage unit, which is configured to store a plurality of temperature compensation values corresponding to a plurality of binary codes generated by the coder.

8. The display device as claimed in claim 7, wherein the control circuit further comprises a micro control unit electrically coupled to the coder and the storage unit, and the micro control unit reads a corresponding temperature compensation value from the storage unit according to a binary code the micro control unit receives from the coder.

9. The display device as claimed in claim 8, wherein the control circuit further comprises an adjusting circuit electrically coupled to the temperature sensor, and the adjusting circuit is configured to filter any interference signal associated with the analog signal.

10. The display device as claimed in claim 9, wherein the control circuit further comprises an amplifier electrically coupled between the adjusting circuit and the analog to digital converter.

11. The display device as claimed in claim 1, wherein the display module comprises a flat panel display.

12. The display device as claimed in claim 11, wherein the flat panel display is one of a liquid crystal display, a plasma display, and an organic light emitting display.

13. The display device as claimed in claim 1, further comprising a power circuit electrically coupled to the driving circuit, wherein the power circuit is configured to provide power for the display device.

14. A method for driving a liquid crystal display, comprising:
detecting ambient temperature of the liquid crystal display;
generating temperature compensation values according to the ambient temperature;
generating compensated display signals according to the temperature compensation values; and
outputting the compensated display signals to a display module of the liquid crystal display to drive the display module.

15. The method for driving a liquid crystal display as claimed in claim 14, wherein the step of detecting ambient temperature comprises: providing a temperature sensor; and the temperature sensor detecting the ambient temperature and outputting corresponding analog signals.

16. The method for driving a liquid crystal display as claimed in claim 15, wherein the step of generating temperature compensation values according to the ambient temperature comprises: converting the analog signals to respective digital signals; converting the digital signals to respective binary codes; providing a plurality of temperature compensation values, each of which corresponds to one of the binary codes; and reading a corresponding temperature compensation value according to each of the binary codes.

17. The method for driving a liquid crystal display as claimed in claim 15, wherein the step of generating temperature compensation values according to the ambient temperature further comprises: adjusting the analog signals so as to filter incidental interference signals; and amplifying the adjusted analog signals.

18. The method for driving a liquid crystal display as claimed in claim 16, wherein the step of generating compensated display signals according to the temperature compensation values comprises: receiving display signals that are independent of the temperature compensation signal; converting one of the display signals to a display voltage; receiving one of the temperature compensation values; converting the temperature compensation value to a temperature compensation voltage; and adding the temperature compensation voltage to the display voltage to form a compensated display signal.

19. The method for driving a liquid crystal display as claimed in claim 18, wherein the temperature compensation voltage is positive when the temperature compensation value represents a decrease in the ambient temperature, and the temperature compensation voltage is negative when the temperature compensation value represents an increase in the ambient temperature.
